(19) United States
(12) Patent Application Publication
(10) Pub. No.: US 2004/0006151 A1
(43) Pub. Date: Jan. 8, 2004

(54) Adhesive material based on block copolymers having a structure p(a/c)-p(b)-p(a/c)

(76) Inventors: Marc Husemann, Hamburg (DE); Stephan Zollner, Hamburg (DE)

Correspondence Address: Norris McLaughlin & Marcus, 30th Floor, 220 East 42nd Street, New York, NY, 10017, US

(21) Appl. No.: 10/343,185

(22) PCT Filed: Jul. 27, 2001
(86) PCT No.: PCT/EP01/08738

(30) Foreign Application Priority Data
Jul. 28, 2000 (DE) 100 36 803.4

(51) Int. Cl. C08J 3/28

(52) U.S. Cl. 522/134; 523/176; 524/284; 427/208

(57) ABSTRACT

A pressure sensitive adhesive comprising a P(A/C)-P(B)-P(A/C) block copolymer, wherein P(B) is a polymer formed from component B and component B comprises at least one monomer B1, P(B) having a glass transition temperature not higher than 0° C., P(A/C) represents a copolymer block of component A/C, which comprises at least two monomers A1 and C1, P(A/C) having a glass transition temperature of 20° C.-175° C. and C1 comprises at least one cross-linking-enabled functional group.

### DESCRIPTION

The invention relates to pressure sensitive adhesives based on block copolymers of the general type P(A/C)-P(B)-P(A/C).

In the field of pressure sensitive adhesives (PSAs) continuing technological developments in the coating technique mean that there is an ongoing need for new developments. Within the industry, hotmelt processes with solventless coating technology are of increasing importance in the preparation of PSAs, since the environmental regulations are becoming ever more stringent and the prices of solvents continue to rise. Consequently, solvents are to be eliminated as far as possible from the manufacturing operation for PSA tapes. The associated introduction of the hotmelt technology is imposing ever-greater requirements on the adhesives. Acrylic PSAs in particular are the subject of very intensive investigations aimed at improvements. For high-level industrial applications, polyacrylates are preferred on account of their transparency and weathering stability. In addition to these advantages, however, these acrylic PSAs must also meet stringent requirements in respect of shear strength and bond strength. This profile of requirements is met by polyacrylates of high molecular weight and high polarity, with subsequent efficient crosslinking. These high shear strength, polar PSAs, however, possess the disadvantage that they are not well suited to the hotmelt extrusion operation, because high application temperatures are necessary and because, furthermore, shearing within the extruder lowers the molecular weight of the polymer. This damage significantly reduces the level of the adhesive properties. The bond strength and the tack are generally low, since owing to the polar fractions in the adhesives the glass transition temperature is relatively high. The shear strengths of the hotmelt-coated acrylic PSAs, in particular, fall distinctly in comparison to the original, solvent-coated PSA. At the present time, therefore, different concepts aimed at reducing the flow viscosity and thereby facilitating extrusion coating of these PSAs are being investigated.

The industry is pursuing a variety of concepts for achieving this objective. One possibility is the highly efficient crosslinking of a low viscosity, apolar acrylic adhesive not until it is on the backing. Acrylates containing electron donating groups are copolymerized and, during crosslinking by UV or EBC (EBC: electron beam curing), they stabilize free radicals that are formed. Examples thereof are tertiary amine monomers [WO 96/35725], tertiary butylacrylamide monomer [U.S. Pat. No. 5,194,455], and tetrahydrofuryl acrylates [EP 0 343 467 B1]. A further efficient crosslinking concept is the copolymerization of UV photoinitiators into the polyacrylate chain. For- example, benzoin acrylate has been used as a comonomer and the crosslinking has been conducted on the backing using UV light [DE 27 43 979 A1]. In U.S. Pat. No. 5,073,611, on the other hand, benzophenone and acetophenone are used as copolymerizable monomers.

Very efficient chemical crosslinking takes place by radiation in the case of polyacrylates containing double bonds [U.S. Pat. No. 5,741,543].

Styrene-isoprene-styrene (SIS) block copolymers, in contrast, are widespread elastomers for hotmelt-processable PSAs [preparation processes: U.S. Pat. No. 3,468,972; U.S. Pat. No. 3,595,941; application in PSAs: U.S. Pat. No. 3,239,478; U.S. Pat. No. 3,935,338]. Good processing properties are achieved by virtue of a relatively low molecular weight and by virtue of a specific morphology [EP 0 451 920 B1]. These PSAs can be crosslinked very effectively with UV light in the presence of photoinitiators or with electron beams, since the middle blocks contain a large number of double bonds.

Nevertheless, these elastomers possess disadvantages, such as, for example, severe aging under UV light (in other words in daylight as well) and in an atmosphere containing oxygen/ozone. Another property which is very adverse for application is the relatively low thermal shear strength. These PSAs are therefore not suitable for relatively long-term outdoor bonds and for applications in relatively high temperature ranges. The same also applies to other block copolymers which possess a middle block containing at least one double bond [U.S. Pat. No. 5,851,664].

One solution to the problem of aging, hotmelt processability, high cohesion, and efficient chemical crosslinking by radiation is provided by the combination of SIS polymers with polyacrylates. Accordingly, US H1,251 describes, for hotmelt applications, diene copolymers containing acrylate, although these copolymers are likewise subject to aging, owing to the large number of double bonds which remain.

U.S. Pat. No. 5,314,962 describes A-B-A block copolymers as elastomers for adhesives, but these possess only A domain formation as a cohesion-forming criterion and therefore lack great shear strength, especially at high temperatures.

EP 0 921 170 A1 describes A-B-A block copolymers which have been modified with additions of resin. Here, no crosslinking has been carried out, so that in this case as well the shear strength of the PSAs described is very low.

It is an object of the invention, therefore, to provide improved pressure sensitive adhesives based on polyacrylate which exhibit the disadvantages of the prior art only to a reduced extent, if at all, and which thus show minor aging also in the crosslinked state and which, in particular, are suitable for processing by the hotmelt process and for use as hotmelt adhesives, without losing the properties which are advantageous for use as a PSA.

This object is achieved by the pressure sensitive adhesive of the invention as specified in the main claim. The subclaims relate to improved embodiments of these pressure sensitive adhesives, to a process for preparing them, and to their use.

The main claim relates accordingly to a pressure sensitive adhesive based on block copolymers of the general type P(A/C)-P(B)-P(A/C), each block copolymer being composed of one middle copolymer block P(B) and two end polymer blocks P(A/C), where

P(B) represents a (co)polymer block obtainable from a component B which is composed of at least one monomer B1, the glass transition temperature of the (co)polymer block P(B) being not higher than 0° C.,

P(A/C) represents a copolymer block obtainable from a component A/C which is composed of at least two monomers A1 and C1, the copolymer block P(A/C) possessing a glass transition temperature of from 20° C. to 175° C., and at least one monomer C1 contains at least one functional group which is capable of crosslinking,

the (co)polymer block P(B) is insoluble in the (co)polymer block P(A), the (co)polymer blocks P(A) and P(B) are immiscible.

In one first advantageous embodiment of this invention the functional group of the monomers C1 that is capable of crosslinking is an unsaturated group which is capable of radiation-chemical crosslinking, in particular of a crosslinking which is brought about by UV irradiation or by irradiation with electron beams. In a particularly favorable way it can be an unsaturated alkyl radical which contains at least one C—C double bond.

For acrylates modified with double bonds, acrylated cinnamic esters are especially advantageous in the sense of the invention.

Another very favorable embodiment of the inventive pressure sensitive adhesive possesses crosslinking-capable functional groups of the monomers C1 that are capable of a crosslinking reaction by virtue of the influence of thermal energy.

Very preferably for the inventive pressure sensitive adhesive, the functional groups capable of thermal crosslinking are hydroxyl, carboxyl, epoxy, acid amide, isocyanato or amino groups.

As monomers C1 it is preferred to use acrylic monomers or vinyl monomers which, alone or in combination with the monomers A1, raise the glass transition temperature of the copolymer block P(A/C) to above 20° C.

Particularly preferred examples of monomers C1 are acrylated photoinitiators, such as, for example, benzoin acrylate or acrylated benzophenone, hydroxyethyl methacrylate, hydroxypropyl methacrylate, acrylic acid, methacrylic acid, allyl alcohol, maleic anhydride, itaconic anhydride, itaconic acid, acrylamide, and glyceridyl methacrylate, this list not being conclusive.

As monomers for component B it is advantageous to use acrylic monomers or vinyl monomers, including such monomers in combination with one another, the glass transition temperature of the middle block being below 0° C.

In one very advantageous embodiment of the pressure sensitive adhesive of the invention the monomers used for component B comprise one or more compounds which can be described by the following general formula.

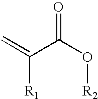

Here, R₁=H or CH₃, the radical R₂ is chosen from the group of the branched or unbranched, saturated alkyl groups having from 4 to 14 carbon atoms.

Acrylic monomers which are used preferentially as component A for the inventive pressure sensitive adhesive include acrylic and methacrylic esters with alkyl groups composed of from 4 to 14 carbon atoms, preferably from 4 to 9 carbon atoms. Specific examples, without wishing to be restricted by this list, are n-butyl acrylate, n-pentyl acrylate, n-hexyl acrylate, n-heptyl acrylate, n-octyl acrylate, n-nonyl acrylate, and branched isomers thereof, such as 2-ethylhexyl acrylate, for example.

As monomers for component B use is additionally made, optionally, of vinyl monomers from the following groups:

vinyl esters, vinyl ethers, vinyl halides, vinylidene halides, vinyl compounds with aromatic rings and heterocycles in the α-position.

Here again, nonexclusive mention may be made of some examples: vinyl acetate, vinylformamide, vinylpyridine, ethyl vinyl ether, vinyl chloride, vinylidene chloride, acrylonitrile.

As monomers A1 it is preferred to choose monomers which are capable of forming a 2-phase domain structure with the copolymer blocks P(B). In the extreme case, A1 and C1 are identical. A prerequisite for this is the immiscibility of the blocks P(B) with the blocks P(A/C). Within the 2-phase domain structure regions are formed in which the P(A/C) blocks of different (and also, where appropriate, identical) chains mix with one another. These domains, as they are known, are embedded in a P(B) matrix. A 2-phase domain structure of this kind characteristically possesses two glass transition temperatures.

With the formation of two phases having different properties, hard blocks P(A/C) are obtained alongside soft blocks P(B).

Advantageous examples of compounds which can be used as monomers A1 are vinylaromatics, methyl methacrylates, cyclohexyl methacrylates, isobornyl methacrylates or acrylic acid. Particularly preferred examples of monomers A1 are methyl methacrylate and styrene.

A further preferred characteristic of these block copolymers P(A/C)-P(B-)-P(A/C) is that the molecular weight lies between 5,000 and 600,000 g/mol, more preferably between 10,000 and 300,000 g/mol. The fraction of the polymer blocks P(A/C) lies advantageously between 10 and 60 percent by weight of the entire block copolymer, more preferably between 15 and 40% by weight. The weight fraction of monomers C1 in relation to monomers A1 lies very advantageously between 0.1 and 20, more preferably between 0.5 and 5.

For preparing the block copolymers of the invention it is possible to make use of any controlled-growth polymerizations which proceed in accordance with free-radical mechanisms, such as, for example, ATRP (atom-transfer radical polymerization), polymerization controlled by nitroxide or TEMPO (2,2,6,6-tetramethyl-1-piperidinyloxy pyrrolidinyloxyl) and/or its derivatives, or polymerization by the RAFT process (rapid addition-fragmentation chain transfer). For the preparation it is possible, for example, to use a difunctional initiator which in one step initiates the polymerization of the monomers B1 and then in a second step copolymerizes component A/C in order to introduce the end blocks (II), it being possible as an option to isolate the intermediate. I-R-I in the reaction equation which follows represents the difunctional initiator containing the functional groups I.

$$I \text{-} R \text{-} I {⟶}^{B} I \text{-} P ( B ) \text{-} R \text{-} P ( B ) \text{-} I {⟶}^{A / C} I \text{-} P ( A / C ) \text{-} P ( B ) \text{-} R \text{-} P ( B ) \text{-} P ( A / C ) \text{-} I \qquad ( II )$$

In addition, the triblock copolymer may be prepared by free-radical recombination of the macromonomers P(A/C)-P(B) * (III).

2 P(A/C)-P(B)*→P(A/C)-P(B)-P(B)-P(A/C) (III)

For polymerizing the block copolymers it is possible with preference to use nitroxide regulators for free-radical control. The polymerization may be conducted in the presence of one or more organic solvents and/or in the presence of water or without solvent. It is preferred to use as little solvent as possible. The polymerization time, depending on conversion rate and temperature, is between 6 and 48 h.

In the case of solution polymerization, preferred solvents used are esters of saturated carboxylic acids (such as ethyl acetate), aliphatic hydrocarbons (such as n-hexane or n-heptane), ketones (such as acetone or methyl ethyl ketone), special boiling point spirit or mixtures of these solvents. For polymerization in aqueous media or in mixtures of organic and aqueous solvents, it is preferred to add emulsifiers and stabilizers for the polymerization. Polymerization initiators used include customary radical-forming compounds such as, for example, peroxides, azo compounds, and peroxosulfates. Mixtures of initiators are also outstandingly suitable. For free-radical stabilization use is made of nitroxides of type (IVa) or (IVb)

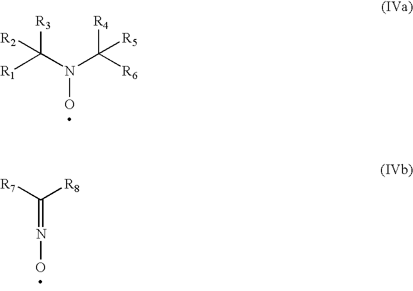

where R₁, R₂, R₃, R₄, R₅, R₆, R₇ and R₈ independently of one another denote the following compounds or atoms:

i) halides, such as chlorine, bromine or iodine, for example

ii) linear, branched, cyclic and heterocyclic hydrocarbons having 1-20 carbon atoms, which may be saturated, unsaturated, and aromatic,

iii) esters —COOR₉, alkoxides —OR₁₀ and/or phosphonates —PO(OR₁₁)₂, where R₉, R₁₀ or R₁₁ stand for radicals from group ii).

The compounds (IVa) or (IVb) may also be attached to polymer chains of any kind and may therefore be utilized for synthesizing the block copolymers, as macroradicals or macro regulators. Macromolecules of this kind may be formed, for example, during the polymerization operation.

Controlled regulators for the polymerization compounds of the following kind are more preferable:

2,2,5,5-tetramethyl-1-pyrrolidinyloxyl (PROXYL), 3-carbamoyl-PROXYL, 2,2-dimethyl 4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL

2,2,6,6-tetramethyl-1-piperidinyloxy pyrrolidinyl-oxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyl-oxyl, 2,2,6-trimethyl-6-ethyl-1-piperidinyloxyl

N-tert-butyl-1-phenyl-2-methyl propyl nitroxide

N-tert-butyl-1-(2-naphthyl)-2-methyl propyl nitroxide,

N-tert-butyl-1-diethylphosphono-2,2,-dimethyl propyl nitroxide

N-tert-butyl-1-dibenzylphosphono-2,2-dimethyl propyl nitroxide

N-(1-phenyl-2-methylpropyl)-1-diethylphosphono-1-methyl ethyl nitroxide

di-t-butyl nitroxide

diphenyl nitroxide

T-butyl t-amyl nitroxide

As a further controlled polymerization method use is made of atom transfer radical polymerization ATRP, in which case as initiator it is preferred to use monofunctional or difunctional secondary or tertiary halides and, for the abstraction of the halide(s), complexes of Cu, of Ni, of Fe, of Pd, of Pt, of Ru, of Os, of Rh, of Co, of Ir, of Cu, of Ag or of Au [EP 0 824 111; EP 0 826 698; EP 0 824 110; EP 0 841 346; EP 0 850 957]. The various possibilities of ATRP are further described in U.S. Pat. No. 5,945,491, U.S. Pat. No. 5,854,364, and U.S. Pat. No. 5,789,487.

As a preferred variant, the RAFT process (reversible addition fragmentation chain transfer) is carried out. The process is described in detail in WO 98/01478 and WO 99/31144. Suitable with particular advantage for preparing block copolymers are trithiocarbonates [Macromolecules 2000, 33, 243-245], which in a first step randomly copolymerize monomers of type A1 and C1 and subsequently can be isolated or can be used directly for the subsequent polymerization of monomer B1.

In order to prepare a pressure sensitive adhesive the block copolymers described so far are processed further in solution or from the melt. Suitable solvents are one or more organic solvents. In order to produce a pressure sensitive adhesive tape the block copolymer must be modified with resins. Examples of resins which can be used include terpene resins, terpene phenol resins, C₅ and C₉ hydrocarbon resins, pinene resins, indene resins, and rosins, alone and also in combination with one another. In principle, however, it is possible to use all resins which are soluble in the corresponding polyacrylate P(B); reference may be made in particular to all aliphatic, aromatic, alkylaromatic hydrocarbon resins, hydrocarbon resins based on pure monomers, hydrogenated hydrocarbon resins, functional hydrocarbon resins, and also natural resins. The weight fraction of the resins within the block copolymer is preferably between 0 and 50%, more preferably between 20 and 40%.

In addition, additives are optionally added in the course of the preparation and/or processing operation, such as aging inhibitors, compounding agents, light stabilizers, ozone protectants, fatty acids, plasticizers, nucleators, blowing agents, accelerators and/or various fillers (for example, carbon black, TiO₂, solid or hollow beads of glass or other materials, nucleators).

In one advantageous development, crosslinker substances which are soluble in P(A/C) or compatible with P(A/C) are added. Examples of suitable crosslinkers include metal chelates, polyfunctional isocyanates, polyfunctional amines or polyfunctional alcohols. Polyfunctional acrylates may also be added advantageously as crosslinkers.

In one advantageous development for crosslinking with UV light, UV photoinitiators are added to the block copolymers. Useful photoinitiators which can be used to very good effect in the inventive sense are benzoin. ethers, such as benzoin methyl ether and benzoin isopropyl ether, for example, substituted aceto-phenones, such as 2,2-diethoxyacetophenone (available as Irgacure 651 from Ciba Geigy), 2,2-dimethoxy-2-phenyl-1-phenylethanone, dimethoxyhydroxyaceto-phenone, substituted alpha-ketols, such as 2-methoxy-2-hydroxypropiophenone, for example, aromatic sulfonyl chlorides, such as 2-naphthylsulfonyl chloride, for example, and photoactive oximes, such as 1-phenyl-1,2-propanedione 2-(o-ethoxycarbonyl) oxime.

A feature of one further development, which makes the process of the invention particularly advantageous for the production of adhesive tapes, for example, is that the pressure sensitive adhesive is processed further from the melt, and that it is applied in particular to a backing.

As backing material, for adhesive tapes for example, it is possible in this context to use the materials which are customary and familiar to the skilled worker, such as films (polyesters, PET, PE, PP, BOPP, PVC), nonwovens, foams, wovens, and woven films, and also release paper (glassine, HDPE, LDPE). This list is not conclusive.

The crosslinking of the hotmelt pressure sensitive adhesives of the invention is accomplished by brief UV irradiation in the range of 200-400 nm using standard commercial high-pressure or medium-pressure mercury lamps with an output, for example, of from 80 to 200 W/cm or by thermal crosslinking in a temperature range between 70-140° C. or by ionizing radiation, such as electron beam curing, for example. For UV cross-linking it may be appropriate to adapt the lamp output to the web speed or to carry out partial shading of the web, while running it slowly, in order to reduce the thermal stress to which it is subjected. The irradiation time is governed by the construction and output of the respective lamps.

The invention further relates to the use of the pressure sensitive adhesive thus obtained for an adhesive tape, in which case the acrylic pressure sensitive adhesive is present as a single-side or both-sides film on a backing.

The pressure sensitive adhesives of the invention are distinguished by high thermal stability with good properties in respect of their thermal shear strength.

The intention is to illustrate the invention below by a number of examples, without thereby wishing to subject it to any unnecessary restriction.

As a function of the desired technical adhesive properties of the acrylic hotmelts, a selection of acrylic and vinylic monomers is made. Quantities, proportions, and percentage fractions are based on the total amount of the monomers.

### EXAMPLES

Test Methods

The following test methods were employed for evaluating the technical adhesive properties of the PSAs prepared. For testing, films made of polyethylene glycol terephthalate (Examples 1 to 6) or siliconized release papers (Examples 7 to 12) were coated with adhesive at a rate of 50 g/m².

Shear Strength (Test A1, A2)

A strip of the adhesive tape, 13 mm wide, was applied to a smooth, cleaned steel surface. The application area was 20 mm×13 mm (length×width). The following procedure was then undertaken:

Test A1: At room temperature, a 2 kg weight was fastened to the adhesive tape and the time recorded until the weight fell off.

Test A2: At 70° C., a 1 kg weight was fastened to the adhesive tape and the time recorded until the weight fell off.

The shear stability times measured are each reported in minutes and correspond to the average of three measurements.

180° Bond Strength Test (Test B)

A strip, 20 mm wide, of an acrylate pressure adhesive applied as a film to a polyester was applied to steel plates. The PSA strip was pressed onto the substrate twice using a 2 kg weight. The adhesive tape was then immediately peeled from the substrate at 300 mm/min and at an angle of 180°. The steel plates were washed twice with acetone and once with isopropanol. All measurements were conducted at room temperature under climate-controlled conditions.

The results of the measurements are reported in N/cm and are averaged from three measurements.

Preparation of the Samples

The acrylates, methacrylates, and styrene used are available commercially. Benzoin acrylate was prepared in accordance with DE 27 43 979 A1. The monomers were purified by distillation before being used.

Preparation of the Trithiocarbonate

Trithiocarbonate (V) as a regulator was prepared in accordance with Macromolecules 2000, 33, 243-245 and Synth. Commun. 1988, 18, 1531-1536.

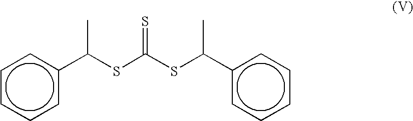

Procedure for the Polymerizations

### Example 1

A 500 ml Schlenk vessel was charged with 400 ml of acrylic acid, 3.47 g of the trithiocarbonate (V) (0.01172 mol) butyl acrylate and 0.06 g of azoiso-butyronitrile (AIBN), the vessel was degassed three times and then the polymerization was conducted under argon. For initiation, the reaction mixture was heated to 65° C. and polymerized for 24 h with stirring. For isolation, the reaction mixture was cooled to RT and the product was then analyzed via GPC (Mₙ=40,200, M_{w/n}=1.24).

A conventional polymerizations reactor was then charged with 32 g of trithiocarbonate-functionalized poly-acrylic acid, 357 g of n-butyl acrylate and 0.12 g of azoisobutyronitrile (AIBN). After argon had been passed through the reactor for 20 minutes and the reactor had been degassed twice, it was heated to 65° C. with stirring and held at this temperature for 24 h.

For isolation, the reaction mixture was cooled to RT and the product was analyzed via GPC (Mₙ=201,000, M_{w/n}=1.43).

The block copolymer was spread at 50 g/m² onto a siliconized release paper and then dried at 120° C. for 15 minutes. To analyze the technical adhesive properties, test methods A and B were carried out.

### Comparative Example 2

A reactor conventional for free-radical polymerizations was charged with 40 g of acrylic acid, 360 g of 2-ethylhexyl acrylate and 266 g of acetone/isopropanol (90:10). After nitrogen gas had been passed through the reaction solution for 45 minutes, with stirring, the reactor was heated to 58° C. and 0.4 g of AIBN [(2,2′-azobis(2-methylbutyronitrile)] was added. Thereafter the external heating bath was heated to 75° C. and the reaction was carried out constantly at this external temperature. After 2 h the next addition of 0.4 g of AIBN [(2,2′-azobis(2-methylbutyronitrile)] was made. After 4 and 8 h, dilution was carried out in each case with 200 g of acetone/isopropanol mixture (90:10). After a reaction time of 36 h the polymerization was terminated and the reaction vessel was cooled to room temperature. The block copolymer was spread at 50 g/m² onto a siliconized release paper and then dried at 120° C. for 15 minutes. To analyze the technical adhesive properties, test methods A and B were carried out.

### Example 3

The procedure of Example 1 was repeated. The polymer was blended in toluene with 0.6% by weight of aluminum(III) acetylacetonate and the blend was applied at a rate of 50 g/m² to a SARAN-primed PET backing 23 μm thick, and dried at 120° C. for 15 minutes. To analyze the technical adhesive properties, test methods A and B were carried out.

### Comparative Example 4

The procedure of Example 2 was repeated. The polymer was blended in toluene with 0.6% by weight of aluminum(III) acetylacetonate and the blend was applied at a rate of 50 g/m² to a SARAN-primed PET backing 23 μm thick, and dried at 120° C. for 15 minutes. To analyze the technical adhesive properties, test methods A and B were carried out.

### Example 5

A 500 ml Schlenk vessel was charged with 396 g of styrene and 4 g of benzoin acrylate and 3.47 g of the trithiocarbonate (V) (0.01172 mol), the vessel was degassed three times and then the polymerization was conducted under argon. For initiation, the reaction mixture was heated to 110° C. and polymerized for 30 h with stirring. For isolation, the reaction mixture was cooled to RT and the polymer was dissolved in 1000 ml of dichloromethane and then precipitated from 7.5 L of methanol with vigorous stirring. The precipitate was filtered off on a frit and then analyzed via GPC (Mₙ=33,200, M_{w/n}=1.43).

A reactor conventional for free-radical polymerizations was charged with 32 g of the polymer prepared above, 357 g of n-butyl acrylate and 0.12 g of azoisobutyro-nitrile (AIBN). After argon had been passed through the reactor for 20 minutes and the reactor had been degassed twice, it was heated to 60° C. with stirring and held at this temperature for 24 h.

For isolation, the block copolymer was cooled to RT and the product was analyzed via GPC (Mₙ=188,000, M_{w/n}=1.56).

The block copolymer was spread at 50 g/m² onto a siliconized release paper and then dried at 120° C. for 15 minutes and subsequently irradiated at 20 m/min using a medium-pressure mercury lamp (200 W/cm) with 2 passes through the lamp. To analyze the technical adhesive properties, test methods A and B were carried out.

### Example 6

A 500 ml Schlenk vessel was charged with 396 g of styrene and 4 g of acrylated benzophenone (Ebecryl 36™, UCB) and 3.47 g of the trithiocarbonate (V) (0.01172 mol), the vessel was degassed three times and then the polymerization was conducted under argon. For initiation, the reaction mixture was heated to 110° C. and polymerized for 30 h with stirring. For isolation, the reaction mixture was cooled to RT and the polymer was dissolved in 1000 ml of dichloromethane and then precipitated from 7.5 L of methanol with vigorous stirring. The precipitate was filtered off on a frit and then analyzed via GPC (Mₙ=32,700, M_{w/n}=1.46). A reactor conventional for free-radical polymerizations was charged with 32 g of the polymer prepared above, 450 g of 2-ethylhexyl acrylate and 0.12 g of azoiso-butyronitrile (AIBN). After argon had been passed through the reactor for 20 minutes and the reactor had been degassed twice, it was heated to 60° C. with stirring and held at this temperature for 24 h.

For isolation, the block copolymer was cooled to RT and the product was analyzed via GPC (Mₙ=180,000, M_{w/n}=1.59).

The block copolymer was spread at 50 g/m² onto a siliconized release paper and then dried at 120° C. for 15 minutes and subsequently irradiated at 20 m/min using a medium-pressure mercury lamp (200 W/cm) with 2 passes through the lamp. To analyze the technical adhesive properties, test methods A and B were carried out.

### Comparative Example 7

Trithiocarbonate-Functionalized Polystyrene (A)

A 500 ml Schlenk vessel was charged with 400 ml of styrene and 3.47 g of the trithiocarbonate (V) (0.01172 mol), the vessel was degassed three times and then the polymerization was conducted under argon. For initiation, the reaction mixture was heated to 110° C. and polymerized for 30 h with stirring. For isolation, the reaction mixture was cooled to RT and the polymer was dissolved in 1000 ml of dichloromethane and then precipitated from 7.5 L of methanol with vigorous stirring. The precipitate was filtered off on a frit and then analyzed via GPC (Mₙ=34,200, M_{w/n}=1.17).

A reactor conventional for free-radical polymerizations was charged with 32 g of trithiocarbonate-functionalized polystyrene (A), 357 g of n-butyl acrylate and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the block copolymer PS-PBuA-PS was cooled to RT and analyzed via GPC (Mₙ=181,000, M_{w/n}=1.39).

The block copolymer was spread at 50 g/m² onto a siliconized release paper and then dried at 120° C. for 15 minutes. To analyze the technical adhesive properties, test methods A and B were carried out.

Results

### Examples 1 to 4

The table below lists the technical adhesive properties of these compositions.

TABLE 1

| | | | |
|---|---|---|---|
| | | | BS-steel |
| Example | SST RT/A1 | SST 70° C./A2 | [N/cm]/B |

| | | | |
|---|---|---|---|
| 1 | 1823 | 597 | 5.0 |
| 2 | 2 | 8 | 5.8 |
| 3 | +10000 | +10000 | 3.6 |
| 4 | +5436 | 4884 | 3.8 |

Application rate: 50 g/m².
SST: Shear stability times [min]
RT: Room temperature
BS: Bond strength on steel

The examples in Table 1 demonstrate that, as a result of the block structure, the cohesion of the adhesives increases even without additional physical cross-linking. Example 1 and Example 2 demonstrate this. The reference Example 2 was prepared conventionally by random copolymerization of butyl acrylate and acrylic acid. The high proportion of isopropanol in the solvent lowered the molecular weight, so that the weight averages of Examples 1 and 2 are approximately comparable with one another. As a result of the formation of domains of the polyacrylic acid in Example 1, there is already a marked rise in the cohesion of the pressure sensitive adhesive. As a result of the absent crosslinking, Example 2 possesses virtually no cohesion. In Examples 3 and 4, Examples 1 and 2 were crosslinked thermally using an aluminum chelate, the concentration of crosslinker being kept constant. Through the further crosslinking of the hard domains, by chemical bonds, there is an increase in particular in the thermal shear strength of the pressure sensitive adhesive (see Example 3). As a result of the additional crosslinking with aluminum chelate there is also a rise in the cohesion of Example 2, although the shear strength level of the block copolymer is not achieved. The bond strengths on steel correlate in each case to the hardness of the individual PSAs.

Examples 5-7

Table 2 below lists the technical adhesive properties of these examples.

TABLE 2

| | | | BS-steel |
|---|---|---|---|
| Example | SST RT/A1 | SST 70° C./A2 | [N/cm]/B |
| 5 | +10000 | +10000 | 2.7 |
| 6 | +10000 | +10000 | 2.8 |
| 7 | 807 | 164 | 2.6 |

Application rate: 50 g/m².
SST: Shear stability times [min]
RT: Room temperature
BS: Bond strength on steel

Examples 5-7 demonstrate that with UV photoinitiators as well it is possible to stabilize further the hard end blocks. This applies in turn to the thermal shear strength of the PSAs. The reference Example 7 possesses only a very low cohesion at 70° C. If, in contrast, UV photoinitiators are implemented into the hard end blocks and these are crosslinked with UV light, there is a marked rise in the internal strength of these hard domains and thus an increase in the shear strength—especially the thermal shear strength—of the PSAs, as can be seen from Examples 5 and 6.

1. A pressure sensitive adhesive based on block copolymers of the general type P(A/C)-P(B)-P(A/C), each block copolymer being composed of one middle copolymer block P(B) and two end polymer blocks P(A/C), characterized in that
P(B) represents a (co)polymer block obtainable from a component B which is composed of at least one monomer B1, the glass transition temperature of the (co)polymer block P(B) being not higher than 0° C.,
P(A/C) represents a copolymer block obtainable from a component A/C which is composed of at least two monomers A1 and C1, the copolymer block P(A/C) possessing a glass transition temperature of from 20° C. to 175° C., and at least one monomer C1 contains at least one functional group which is capable of crosslinking,
the (co)polymer block P(B) is insoluble in the (co)polymer block P(A), the (co)polymer blocks P(A) and P(B) are immiscible.

2. The pressure sensitive adhesive of claim 1, characterized in that the crosslinking-capable functional group of the at least one monomer C1 is an unsaturated group which is capable of radiation-chemical crosslinking, in particular by crosslinking which is brought about by UV irradiation or by irradiation with electron beams.

3. The pressure sensitive adhesive of at least one of the preceding claims, characterized in that the crosslinking-capable group of the at least one monomer C1 is an unsaturated alkyl radical which contains at least one C—C double bond.

4. The pressure sensitive adhesive of claims 1, characterized in that the crosslinking-capable functional group of the at least one monomer C1 is a group which is capable of a crosslinking reaction by virtue of the influence of thermal energy.

5. The pressure sensitive adhesive of at least one of the preceding claims, characterized in that the crosslinking-capable functional group of the at least one monomer C1 is a hydroxyl, a carboxyl, an epoxy, an acid amide, an isocyanato or an amino group.

6. The pressure sensitive adhesive of at least one of the preceding claims, characterized in that for component A/C, as the monomer C1, use is made of at least one compound which raises the glass transition temperature of the copolymer block P(A/C) to T_{G}>20° C.

7. The pressure sensitive adhesive of claim 1, characterized in that for component B use is made of at least one monomer B1 in accordance with the following general formula 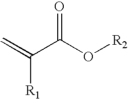
where R₁=H or CH₃ and R₂ is selected from the group of the branched or unbranched, saturated alkyl groups having 4 to 14 carbon atoms.

8. The pressure sensitive adhesive of at least one of the preceding claims, characterized in that for component A/C, monomers A1 and C1 are preferably selected such that the resultant copolymer blocks P(A/C) are capable of forming a two-phase domain structure with the (co)polymer blocks P(B).

9. The pressure sensitive adhesive of at least one of the preceding claims, characterized by an average molecular weight of between 5,000 and 600,000 g/mol, in particular between 10,000 and 300,000 g/mol.

10. The pressure sensitive adhesive of at least one of the preceding claims, characterized in that the fraction of the (co)polymer blocks P(A/C) lies between 10 and 60% by weight, in particular between 15 and 40% by weight, of the entire block copolymer.

11. The pressure sensitive adhesive of at least one of claims 2 to 10, characterized in that the weight fraction of the monomer C1 in relation to the monomer A1 lies between 0.1 and 20, in particular between 0.5 and 10.

12. The pressure sensitive adhesive of at least one of the preceding claims, characterized in up to 50% by weight, in particular from 20 to 40% by weight, of resins, and/or in that additives, especially crosslinkers, aging inhibitors, light stabilizers, ozone protectants, fatty acids, plasticizers, nucleators, blowing agents, accelerators and/or fillers, have been added.

13. The use of a pressure sensitive adhesive of at least one of the preceding claims for an adhesive tape provided with the pressure sensitive adhesive on one or both sides, in particular for an adhesive tape for bonds on apolar surfaces, with the pressure sensitive adhesive having been applied—preferably from the melt—as a single-side or both-sides film on a backing.

14. A process for producing a pressure sensitive adhesive of at least one of the preceding claims, characterized in that the pressure sensitive adhesive is crosslinked with ultraviolet or ionizing radiation.
